(19) United States
(12) Patent Application Publication
(10) Pub. No.: US 2007/0253060 A1
(43) Pub. Date: Nov. 1, 2007

(54) Polarizer, Polarizing Plate,Optical Film, and Image Display

(75) Inventors: Masahiro Yoshioka, Osaka (JP); Minoru Miyatake, Osaka (JP); Yuuji Saiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/661,362

(22) PCT Filed: Aug. 26, 2005
(86) PCT No.: PCT/JP05/15546

§ 371 Date: Feb. 28, 2007

(30) Foreign Application Priority Data
Sep. 1, 2004 (JP) 2004-254429

(51) Int. Cl. G02B 5/30

(52) U.S. Cl. 359/500; 359/485

(57) ABSTRACT

A polarizer of the invention comprises a film having a structure that includes: a matrix formed of an optically-transparent resin having a polyene structure; and minute domains dispersed in the matrix and/or fibers embedded in the matrix without forming voids. The polarizer has a high transmittance and a high degree of polarization.

### TECHNICAL FIELD

The present invention relates to a polarizer. This invention also relates to a polarizing plate and an optical film using the polarizer concerned. Furthermore, this invention relates to an image display, such as a liquid crystal display, an organic electroluminescence display, a CRT and a PDP using the polarizing plate and the optical film concerned.

### BACKGROUND ART

Liquid crystal display are rapidly developing in market, such as in clocks and watches, cellular phones, PDAs, notebook-sized personal computers, and monitor for personal computers, DVD players, TVs, etc. In recent years, the range of uses thereof increases from the indoor applications to outdoor, vehicle interior, ship, and aircraft applications, and other applications. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, in time, for example, since it has a high transmittance and a high polarization degree, polyvinyl alcohols having a structure in which iodine is absorbed and then stretched, that is, iodine based polarizers are widely used (for example, JP-A No 2001-296427). However, if iodine based polarizer is used for applications requiring high resistance to heat and humidity, such as outdoor applications and vehicle interior applications, there is a high possibility that defects will occur, such as iodine sublimation, a change in the complex state and polarizer deformation caused by contraction stress or the like. Dichroic dye based polarizer is also used in which dichroic dyes are used in place of iodine compounds. Even in such dichroic dye based polarizer, the major materials that form the polarizers resemble those in iodine based polarizer and have not yet achieved sufficiently high resistance to heat and humidity.

Against these problems, for example, there is proposed a polyene based polarizer that is produced by a process including the steps of partially dehydrating a polyvinyl alcohol resin film and then stretching the film in a single direction to form a conjugated polyene (JP-A No. 2003-240952). Such a polyene based polarizer is resistant to heat and humidity but has a problem in which uniformity of various optical properties such as polarization degree and uniformity of color and the like are generally lower in the polyene based polarizer than in iodine based polarizer or dichroic dye based polarizer. Practically, therefore, polyene based polarizer is only used in very limited applications where only resistance to heat and humidity is important, while visual characteristics such as definition and contrast do not matter.

### DISCLOSURE OF INVENTION

An object of the invention is to provide a polyene based polarizer having high transmittance and high degree of polarization and featuring reduced unevenness.

Besides, another object of the invention is to provide a polarizing plate and an optical film using the polarizer concerned. Furthermore, another object of the invention is to provide an image display using the polarizer, the polarizing plate, and the optical film concerned.

As a result of examination wholeheartedly performed by the present inventors that the above subject should be solved, it was found out that the above purpose might be attained using polarizers shown below, leading to completion of this invention.

The invention is related to a polarizer, comprising a film having a structure that comprises: a matrix formed of an optically-transparent resin having polyene structure; and minute domains dispersed in the matrix and/or fibers embedded in the matrix without forming voids.

The minute domains and/or the fibers of the polarizer are preferably formed of an oriented birefringent material. The direction of orientation of the birefringent material is preferably parallel to the direction of an optical axis in which the difference between the refractive indices of the birefringent material and the optically-transparent resin having the polyene structure is maximum. And it is preferable that the birefringent material shows liquid crystalline at least in orientation processing step.

The polarizer of the invention has a structure including: a matrix formed of an optically-transparent resin having a polyene structure; and minute domains dispersed in the matrix and/or fibers embedded in the matrix without forming voids. The polarizer of the invention includes a matrix of a polyene structure and thus has good resistance to heat and humidity. The polarizer of the invention also has a scattering anisotropy function together with a polarization function derived from the polyene structure. The two functions produce a synergistic effect so that an improvement in polarization performance can be achieved, an improvement in both transmittance and degree of polarization can be achieved, and the resulting polarizer can have good visibility. In the polarizer of the invention, the uniformity is also high so that unevenness in color can be reduced.

The polyene structure itself also has the function of separating polarized light. Thus, a dichroic light-absorbing material does not necessarily have to be used in the optically-transparent resin. Even when a dichroic light-absorbing material is used, such a material as an iodine light-absorbing material, which has good dichroism but is unstable, does not have to be used, and an absorbing dichroic dye that is stable and generally inexpensive can be used to produce optical properties equal to those of iodine based polarizer.

Scattering performance of anisotropic scattering originates in refractive index difference between matrixes and minute domains and/or the fibers. For example, if materials forming minute domains are liquid crystalline materials, since they have higher wavelength dispersion of Δn compared with optically-transparent resin having polyene structures as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, thus as a whole a polarizer having high polarization and neutral hue may be realized. The same is also applied to the case of using fibers embedded in place of minute domains.

In the above polarizer, it is preferable that the minute domains and/or the fibers have a birefringence of 0.02 or more. In materials used for minute domains and/or the fibers, in the view point of gaining larger anisotropic scattering function, materials having the above birefringence may be preferably used.

In the above polarizer, in a refractive index difference between the birefringent material forming the minute domains and/or the fibers and the optically-transparent resin having polyene structure in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹.

Control of the above refractive index difference (Δn¹) and (Δn²) in each optical axis direction into the above range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in a Δn¹ direction is set 0.03 or more, preferably 0.05 or more, and still preferably 0.10 or more. A refractive index difference (Δn²) in two directions perpendicular to the Δn¹ direction is 50% or less of the above Δn¹, and preferably 30% or less.

In the polarizer, an absorption axis of the optically-transparent resin having polyene structure is preferably oriented in the Δn¹ direction of the birefringent material forming the minute domains.

The optically-transparent resin having polyene structure is orientated so that an absorption axis of the material may become parallel to the above Δn¹ direction, and thereby linearly polarized light in the Δn¹ direction as a scattering polarizing direction may be selectively absorbed. As a result, on one hand, a linearly polarized light component of incident light in a Δn² direction is not scattered or hardly absorbed by the optically-transparent resin having polyene structure as in conventional iodine based polarizers without anisotropic scattering performance. On the other hand, a linearly polarized light component in the Δn¹ direction is scattered, and is absorbed by the optically-transparent resin having polyene structure. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional polyene polarizers. That is, higher polarization degrees may be attained with same transmittances.

Descriptions for ideal models will, hereinafter, be given. Two main transmittances usually used for linear polarizer (a first main transmittance k₁ (a maximum transmission direction=linearly polarized light transmittance in a Δn² direction), a second main transmittance k₂ (a minimum transmission direction=linearly polarized light transmittance in a Δn¹ direction)) are, hereinafter, used to give discussion.

In commercially available polyene polarizers, when the polyene structure is oriented in one direction, a parallel transmittance and a polarization degree may be represented as follows, respectively:
parallel transmittance=0.5×((k₁)²+(k₂)²) and
polarization degree=(k₁−k₂)/(k₁+k₂).

On the other hand, when it is assumed that, in a polarizer of this invention, a polarized light in a Δn¹ direction is scattered and an average optical path length is increased by a factor of α(>1), and depolarization by scattering may be ignored, main transmittances in this case may be represented as k₁ and k₂′=10^{x} (where, x is α log k₂), respectively

That is, a parallel transmittance in this case and the polarization degree are represented as follows:
parallel transmittance=0.5×((k₁)²+(k₂′)²) and
polarization degree=(k₁−k₂′)/(k₁+k₂′).

When a polarizer of this invention is prepared by a same condition (an amount of dyeing and production procedure are same) as in commercially available polyene polarizer (parallel transmittance 0.355, polarization degree 0.990: k₁=0.630, k₂=0.032×10⁻³), on calculation, when α is 2 times, k₂ becomes small reaching 0.99×10⁻⁷, and as result, a polarization degree improves up to 0.999999, while a parallel transmittance is maintained as 0.355. The above result is on calculation, and function may decrease a little by effect of depolarization caused by scattering, surface reflection, backscattering, etc. As the above equations show, higher value α may give better results and higher dichroic ratio of the dichroic absorbing material such as polyene structure may provide higher function. In order to obtain higher value α, a highest possible scattering anisotropy function may be realized and polarized light in a Δn¹ direction may just be selectively and strongly scattered. Besides, less backscattering is preferable, and a ratio of backscattering strength to incident light strength is preferably 30% or less, and more preferably 20% or less.

In the polarizer, the minute domains of the polarizer preferably have a length of 0.05 to 500 μm in a Δn² direction perpendicular to a Δn¹ direction, wherein the Δn¹ direction is an axis direction in which the difference between the refractive indices of the minute domain-forming material and the optically-transparent resin is maximum, and the Δn² direction is a direction perpendicular to the Δn¹ direction. In the polarizer, which has the structure fibers is embedded in the matrix without forming voids, the fibers preferably have a circular or elliptical cross-section and a diameter in the range of 0.3 to 100 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise. When the fibers are embedded, the fibers preferably have a circular or elliptical cross section and a diameter of 0.3 to 100 μm, more preferably of 5 to 50 μm. If the diameter (maximum diameter) is too small, problems can occur in which the fiber can be easily broken during handling, and air can be easily entrained when the fibers are embedded in the optically-transparent resin. There can also be a problem in which no scattering occurs if the diameter is shorter than the wavelength of light. On the other hand, if the diameter is too large, the ratio of the part occupied by the fibers to the total thickness of the polarizer can be too high, so that there can be a risk of failing to cause effective multiple scattering or a risk of causing unevenness in optical properties such as transparency and polarization degree, due to wide variations in the thickness of the optically-transparent resin with the polyene structure relative to the total thickness of the polarizer.

In the polarizer, as the film, a stretched film produced by stretching is preferably used.

In the polarizer, the optically-transparent resin has a polyene structure and forms a matrix, and the polyene structure exhibits dichroic light-absorbing properties. If necessary, the optically-transparent resin having the polyene structure may contain another type of dichroic light-absorbing material. In this case, the additional dichroic light-absorbing material to be used may have at least an absorption region in the wavelength range of 400 to 700 nm. In addition, the absorption axis of the dichroic light-absorbing material is preferably oriented in the Δn¹ direction.

In the polarizer, in a case the dichroic light-absorbing material is not contained in the matrix formed of the optically-transparent resin having polyene structure, preferably, a transmittance to a linearly polarized light in a transmission direction is 50% or more, a haze value is 10% or less, and a haze value to a linearly polarized light in an absorption direction is 50% or more. On the other hand, in a case the dichroic light-absorbing material is contained in the matrix formed of the optically-transparent resin having polyene structure, preferably, a transmittance to a linearly polarized light in a transmission direction is 70% or more, a haze value is 10% or less, and a haze value to a linearly polarized light in an absorption direction is 50% or more.

A polarizer of this invention having the above transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing.

As a polarizer of this invention, a polarizer is preferable that has as high as possible transmittance to linearly polarized light in a transmission direction, that is, linearly polarized light in a direction perpendicular to a direction of maximal absorption of the dichroic light-absorbing material. In a case the dichroic light-absorbing material is not contained in the matrix, light transmittance is preferably 50% or more when an optical intensity of incident linearly polarized light is set to 100. The light transmittance is preferably 55% or more, and still preferably 60% or more. On the other hand, in a case the dichroic light-absorbing material is contained in the matrix, light transmittance is preferably 70% or more when an optical intensity of incident linearly polarized light is set to 100. The light transmittance is preferably 75% or more, and still preferably 80% or more. Here, a light transmittance is equivalent to a value Y calculated from a spectral transmittance in 380 nm to 780 nm measured using a spectrophotometer with an integrating sphere based on CIE 1931 XYZ standard colorimetric system. In addition, since about 8% to 10% is reflected by an air interface on a front surface and rear surface of a polarizer, an ideal limit is a value in which a part for this surface reflection is deducted from 100%.

It is desirable that a polarizer does not scatter linearly polarized light in a transmission direction in the view point of obtaining clear visibility of a display image. Accordingly, the polarizer preferably has 10% or less of haze value to the linearly polarized light in the transmission direction, more preferably 8% or less, and still more preferably 5% or less. On the other hand, in the view point of covering unevenness by a local transmittance variation by scattering, a polarizer desirably scatters strongly linearly polarized light in a absorption direction, that is, linearly polarized light in a direction for a maximal absorption of the above dichroic light absorbing material. Accordingly, a haze value to the linearly polarized light in the absorption direction is preferably 50% or more, more preferably 70% or more, and still more preferably 80% or more. In addition, the haze value here is measured based on JIS K 7136 (how to obtain a haze of plastics-transparent material).

The above optical properties are obtained by compounding a function of scattering anisotropy with a function of an absorption dichroism of the polyene polarizer. As is indicated in U.S. Pat. No. 2,123,902 specification, JP A No. 9-274108, and JP A No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above optical path length of the polarized light absorbed as is expected, and as a result, the method cannot easily attain a high transmission and a high polarization degree.

The invention is also related to a method for producing the above polarizer, comprising the steps of:

(1) preparing a mixture solution comprising: a resin serving as a raw material for the optically-transparent resin having the polyene structure for forming the matrix; and a material for forming the minute domains that is dispersed in the resin, or impregnating fibers arranged substantially in parallel with the mixture solution or a resin serving as a raw material for the optically-transparent resin having the polyene structure for forming the matrix;

(2) forming the mixture solution or the impregnated fibers of the step (1) into a film; and

(3) turning the film obtained in the step (2) into a polyene by a dehydration reaction.

In the method for producing the polarizer, in a case the film is a stretched film produced by stretching, the method further may comprises the step of (4) orienting (stretching) the film obtained in the step (3).

In the method for producing the polarizer, in a case the dichroic light-absorbing material is contained in the optically-transparent resin having polyene structure, the method further may comprises the step of (5) adding a dichroic light-absorbing material or another resin component containing a dichroic light-absorbing material to the optically-transparent resin having the polyene structure.

The polarizer of the invention is more advantageous in manufacturing process than conventional iodine based polarizer. Specifically, the process of manufacturing iodine based polarizer requires dipping into up to five types of baths (a swelling bath, a dyeing bath, a crosslinking bath, a stretching bath, and a water washing bath) and thus can produce a large amount of waste liquid. In contrast, the process of manufacturing the polarizer of the invention basically requires only an acid treatment bath for polyene production (dehydration reaction) and optionally requires an additional dyeing bath (in which stretching is possible), even in such a case, generally two types of baths in total. Thus, the polarizer of the invention is advantageous in terms of reducing environmental loading based on a reduction in cost and waste liquid.

Besides, this invention is related to a polarizing plate which having a transparent protection layer at least on one side of the above polarizer.

Moreover, this invention is related to an optical film laminated with at least one of the above polarizer and the above polarizing plate.

Furthermore, this invention is related to an image display using the above polarizer, the above polarizing plate, or the above optical film.

### BRIEF DESCRIPTION OF DRAWINGS

FIG. 1 is schematic diagram showing an example of a polarizer of this invention;

FIG. 2 is schematic diagram showing an example of a polarizer of this invention;

FIG. 3 is schematic diagram showing an example of a polarizer of this invention;

FIG. 4 is schematic diagram showing an example of a polarizer of this invention.

### BEST MODE FOR CARRYING OUT THE INVENTION

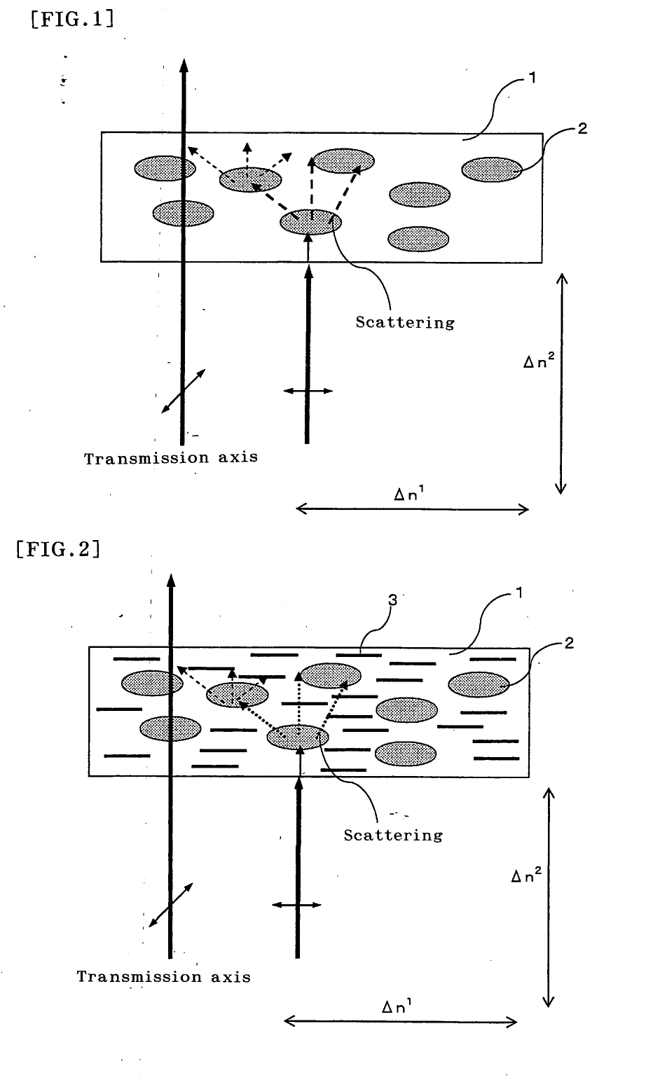

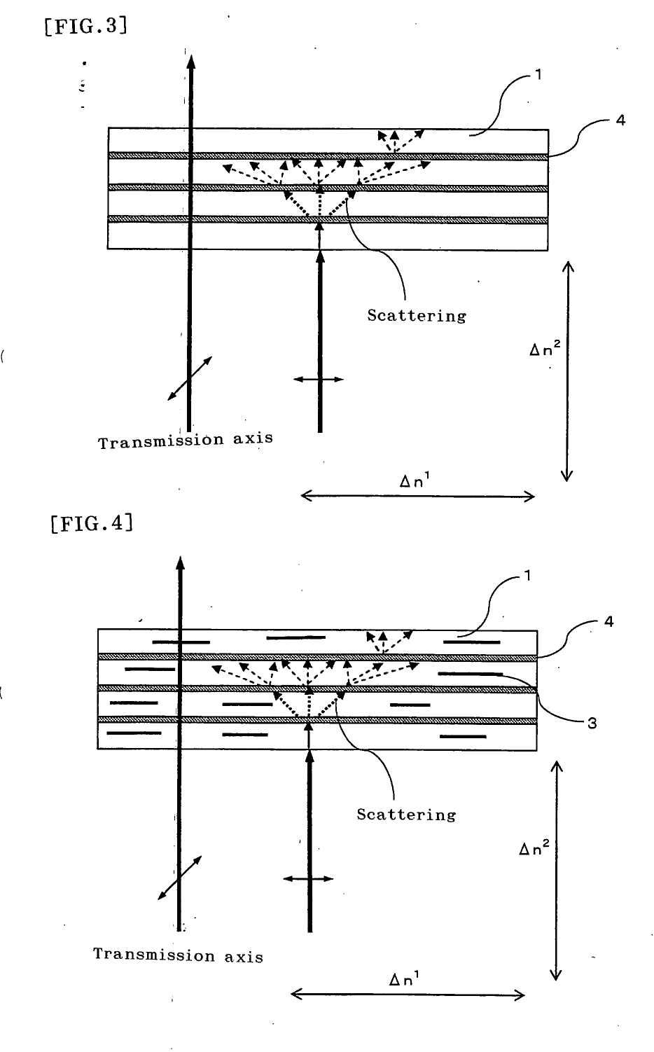

The polarizer of the invention is described below with reference to the drawings. FIGS. 1 to 4 are schematic diagrams of the polarizer of the invention. FIGS. 1 and 2 show cases where the polarizer has a structure including a matrix formed of an optically-transparent resin having a polyene structure and minute domains dispersed in the matrix. In FIG. 1, the optically-transparent resin 1 having the polyene structure forms a film, and the polarizer has a structure including a matrix of the film and minute domains 2 dispersed in the matrix. In FIG. 2, the optically-transparent resin 1 having the polyene structure forms a film, and the polarizer has a structure including a matrix of the film, minute domains 2 dispersed in the matrix, and a dichroic light-absorbing material 3 dispersed in the optically-transparent resin 1 having the polyene structure, which forms the matrix. FIG. 2 shows a case where the dichroic light-absorbing material 3 is oriented in the direction of an axis where the difference between the refractive indices of the minute domains 2 and the optically-transparent resin 1 having the polyene structure is maximum (Δn¹ direction). In FIGS. 3 and 4, the polarizer has a structure including a matrix formed of an optically-transparent resin having a polyene structure and fibers embedded in the matrix without forming voids. In FIG. 3, the optically-transparent resin 1 having the polyene structure forms a film, and the polarizer has a structure including a matrix of the film and fibers 4 embedded in the matrix without forming voids. In FIG. 4, the optically-transparent resin 1 having the polyene structure forms a film, and the polarizer has a structure including a matrix of the film, fibers 4 embedded in the matrix without forming voids, and a dichroic light-absorbing material 3 dispersed in the optically-transparent resin 1 having the polyene structure, which forms the matrix. FIG. 4 shows a case where the dichroic light-absorbing material 3 is oriented in the direction of an axis where the difference between the refractive indices of the minute domains 2 and the optically-transparent resin 1 having the polyene structure is maximum (Δn¹ direction).

In the minute domains 2 or the fibers 4, a polarized light component in the Δn¹ direction is scattered. In FIGS. 1 to 4, an absorption axis is in the Δn¹ direction, which is a direction in the film plane. A transmission axis is in a Δn² direction that is perpendicular to the Δn¹ direction in the film plane. It should be noted that another Δn² direction perpendicular to the Δn¹ direction is the thickness direction.

Any material that has a polyene structure and also has transparency in the visible light region may be used for the optically-transparent resin 1 having the polyene structure, without particular limitations. The optically-transparent resin having the polyene structure may be obtained as a dehydration product of polyvinyl, alcohol, a dehydrochlorination product of polyvinyl chloride, or the like. Polyvinyl alcohol or derivatives thereof may be used as a raw material for the optically-transparent resin having the polyene structure. Polyvinyl alcohol may be produced by hydrolyzing a homopolymer or copolymer of vinyl esters such as vinyl acetate, vinyl pivalate and vinyl formate or vinyl compounds such as tert-butyl vinyl ether, trimethylsilyl ether and benzyl vinyl ether. Examples of polyvinyl alcohol derivatives include polyvinyl formal and polyvinyl acetal, and those modified with olefins such as ethylene and propylene, those modified with unsaturated carboxylic acids such as acrylic acid, methacrylic acid and crotonic acid, those modified with alkyl esters thereof, those modified with acrylamide or the like. The polyvinyl alcohol to be used generally has a degree of polymerization of about 1000 to about 10000 and a saponification degree of about 80 to about 100% by mole.

The polyvinyl alcohol may also contain an additive such as a plasticizer. Examples of the plasticizer include polyols and condensation products thereof, such as glycerin, diglycerin, triglycerin, ethylene glycol, propylene glycol, and polyethylene glycol. While the plasticizer may be used in any amount, the content of the plasticizer in a polyvinyl alcohol film is preferably 20% or less by weight.

In materials forming minute domains, it is not limited whether the material has birefringence or isotropy, but materials having birefringence is particularly preferable. Moreover, as materials having birefringence, materials (henceforth, referred to as liquid crystalline material) showing liquid crystallinity at least at the time of orientation treatment may preferably used. That is, the liquid crystalline material may show or may lose liquid crystallinity in the formed minute domains 2, as long as it shows liquid crystallinity at the orientation treatment time.

As materials forming minute domains 2, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms minute domains 2 while liquid crystallinity are maintained. Although liquid crystalline monomers after orienting can form minute domains 2 in the state of fixed by polymerization, cross-linking, etc., some of the formed minute domains 2 may lose liquid crystallinity.

As the above liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above cyclic units etc. may be mentioned. Crossed-linked structures may be introduced using polymerizable functional groups having two or more acryloyl groups, methacryloyl groups, etc., and durability may also be improved.

Materials forming minute domains 2 are not entirely limited to the above liquid crystalline materials, and non-liquid crystalline resins may be used if they are different materials from the matrix materials. As the above resins, polyvinyl alcohols and derivatives thereof, polyolefins, polyarylates, polymethacrylates, polyacrylamides, polyethylene terephthalates, acrylic styrene copolymes, etc. may be mentioned. Moreover, particles without birefringence may be used as materials for forming the minute domains 2. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming minute domains 2 is of the above liquid crystalline materials, non-liquid crystalline materials may be mixed and used to the above liquid crystalline materials. Furthermore, as materials for forming minute domains 2, non-liquid crystalline materials may also be independently used.

For example, the fibers 4 may be formed of a transparent resin. While the resin may be, but not particularly limited to, isotropic or birefringent, a birefringent material is preferably used. The transparent resin for use in birefringent fibers may be any resin material that is optically-transparent in the visible light region, capable of being formed into fibers by melt spinning or solution spinning, and capable of exhibiting birefringence. Such a transparent resin may be a water-soluble resin such as polyvinyl alcohol and derivatives thereof. Examples of polyvinyl alcohol derivatives include polyvinyl formal and polyvinyl acetal and those modified with olefins such as ethylene and propylene, those modified with unsaturated carboxylic acids such as acrylic acid, methacrylic acid and crotonic acid, those modified with alkyl esters thereof, and those modified with acrylamide or the like. Examples of the optically-transparent resin also include polyvinylpyrrolidone resins and amylose resins. Among them, polyvinyl alcohol and a copolymer of ethylene and vinyl alcohol are preferred.

Examples of the transparent resin also include polyester resins such as polyethylene terephthalate and polyethylene naphthalate; styrene resins such as polystyrene and acrylonitrile-styrene copolymers (AS resins); and olefin resins such as polyethylene, polypropylene, polyolefins having a cyclo system or norbornene structure, and ethylene-propylene copolymers. Examples thereof also include vinyl chloride resins, cellulose resins, acrylic resins, amide resins, imide resins, sulfone polymers, polyethersulfone resins, polyetherether ketone resin polymers, polyphenylene sulfide resins, vinylidene chloride resins, vinyl butyral resins, arylate resins, polyoxymethylene resins, silicone resins, and urethane resins. One or two or more of these resins may be used alone or in combination.

Birefringent fibers for use as the fibers 4 may be prepared, but not particularly limited, by any method such as a method that includes forming the transparent resin into fibers by melt spinning or solution spinning and then stretching the fibers. The stretching method may be any of dry stretching in the air and wet stretching in an aqueous bath. When the wet stretching is used, the aqueous bath may appropriately contain an additive (such as a boron compound such as boric acid or an alkali metal iodide in the case where iodine is used as a dichroic material). The stretch ratio is generally, but not particularly limited to, from about 2 to about 50, more preferably from about 3 to about 30. After the fiber formation, the resulting fibers may be embedded, as they are, in the optically-transparent resin having the polyene structure or may be once stretched at the desired stretch ratio or less and then embedded in the optically-transparent resin having the polyene structure. After processed into a film, the fibers may be stretched together with the optically-transparent resin for the matrix to the desired stretch ratio.

The fibers 4 preferably have, but not limited to, a cross-sectional shape of a circle or an ellipse. If the fiber cross section has an apical angle or no definite form, there can be problems in which the fibers can be easily broken during the fiber formation, undesired scattering can easily occur in some cases, or the air can be easily entrained when the optically-transparent resin is packed between the fibers. From these points of view, the cross section is preferably an ellipse. While the ellipse has any ellipticity (%), the ellipse preferably has an ellipticity close to 100% from a viewpoint of easy shaping. Specifically, the ellipticity is preferably from 5 to 100%, more preferably from 10 to 100%.

The minute domains 2 and fibers 4 (birefringent fibers) preferably have a birefringence (Δn) of at least 0.02. The birefringence (Δn) is defined as Δn=nₑ−nₒ, wherein nₒ is an extraordinary light refractive index (a refractive index in the longitudinal direction), and no is an ordinary light refractive index (a refractive index in the cross-sectional direction). If the birefringence (Δn) is less than 0.02, the scattering effect can be insufficient. The birefringence (Δn) is preferably 0.02 or more, more preferably 0.03 or more, still more preferably 0.05 or more. If the birefringence (Δn) is high, the wavelength dependency can be high so that in some cases, the adjustment of the refractive index can be difficult with the optically-transparent resin 1 in the entire visible wavelength region. Thus, the birefringence (Δn) is preferably 0.4 or less.

In the matrix formed of the optically-transparent resin 1 having the polyene structure, the minute domains 2 are dispersed and/or the fibers 4 are embedded without forming voids. In addition, if necessary, the matrix may contain the dichroic light-absorbing material 3 (with dispersing or dyeing) with which the dichroism of the optically-transparent resin 1 having the polyene structure can be compensated.

Examples of the dichroic light-absorbing material 3 include iodine light-absorbing materials and absorbing dichroic dyes and pigments. For example, the absorbing dichroic dyes disclosed in JP-A Nos. 5-296281, 5-295282, 5-311086, 6-122830, 6-128498, 7-3172, 8-67824, 8-73762, and 8-127727 may be used without limitations. Examples of dichroic dyes that can be preferably used also include the dichroic dyes disclosed in JP-A Nos. 5-53014, 5-53015, 6-122831, 6-265723, 6-337312, 7-159615, 7-318728, 7-325215, 7-325220, 8-225750, 8-291259, 8-302219, 9-73015, 9-132726, 9-302249, 9-302250, 10-259311, 2000-319633, 2000-327936, 2001-2631, 2001-4833, 2001-108828, 2001-240762, 2002-105348, 2002-155218, 2002-179937, 2002-220544, 2002-275381, 2002-357719, 2003-64276, 2-13903, 2-89008, 3-89203, 2003-313451, and 2003-327858, and the dichroic dyes disclosed in JP-A Nos. 9-230142, 11-218610, 11-218611, 2001-27708, 2001-33627, 2001-56412, 2002-296417, 1-313568, 3-12606, and 2003-215338, and the brochure of WO00/37973. It will be understood that the absorbing dichroic dye is not limited to those described above in the invention and that any material capable of dyeing the optically-transparent resin 1 having the polyene structure or any material that can produce dichroism when dispersed may preferably be used.

A resin component other than the optically-transparent resin 1 having the polyene structure may also be dispersed in the matrix-forming optically-transparent resin 1 so as to form additional minute domains other than the birefringent minute domains 2. A fibers produced by melt spinning or solution spinning may also be embedded in the matrix-forming optically-transparent resin 1 so that additional fibers other than the fibers 4 can be added. Only the resin that forms the interior of the minute domains or fibers may be dyed with a dichroic light-absorbing material, or a dichroic light-absorbing material may be dispersed in the minute domains or fibers to produce dichroism. While only one of the structure where minute domains are dispersed and the structure where fibers are embedded has to be formed in the optically-transparent resin, these structures may be used in combination. For example, a combination of at least two types of the structures selected from the group consisting of minute domains made of a liquid-crystalline birefringent material, minute domains containing a dichroic light-absorbing material, birefringent fibers, and fibers containing a dichroic light-absorbing material may be dispersed or embedded at the same time in the matrix-forming optically-transparent resin.

In a process of producing the polarizer of the invention, a film in which the optically-transparent resin 1 having the polyene structure forms a matrix is prepared, while minute domains 2 (for example, an oriented birefringent material made of a liquid-crystalline material) is dispersed into the matrix or while fibers 4 (for example, an oriented birefringent material) is embedded in the matrix without forming voids. The minute domains 2 and the fibers 4 may be used in combination. In the film, the refractive index difference (Δn¹) in the Δn¹ direction and the refractive index difference (Δn²) in the Δn² direction may also be controlled so as to be in the above range.

Manufacturing process of a polarizer of this invention is not especially limited, and for example, the polarizer of this invention may be obtained using following steps:

(1) a step(11) for preparing a mixed solution in which a material for forming minute domains is dispersed in an optically-transparent resin having polyene structure forming a matrix (description is, hereinafter, to be provided, with reference to an example of representation, for a case where a liquid crystalline material is used as a material forming the minute domains. A case by a liquid crystalline material will apply to a case by other materials.), a step(12) for impregnating fibers arranged substantially in parallel with a resin serving as a raw material for the optically-transparent resin having the polyene structure for forming the matrix (description is, hereinafter, to be provided, with reference to an example of representation, for a case where a birefringent material is used as a material forming the fibers.);

(2) forming the mixture solution or the impregnated fibers of the step (1) into a film;

(3) turning the film obtained in the step (2) into a polyene by a dehydration reaction. Further, the polarizer of this invention may be obtained using the step of (4) orienting (stretching) the film obtained in the step (3). In addition, an order of the processes (1) to (4) may suitably be determined. When the step (11) is performed in combination with the step (12) in the step (1), the fibers may be impregnated with the mixture solution prepared with in the step (11).

The step (11) is adopted to form the minute domains in the above step (1), a mixed solution is firstly prepared in which a liquid crystalline material forming minute domains is dispersed in an optically-transparent resin having polyene structure forming a matrix.

A method for preparing the mixed solution concerned is not especially limited, and a method may be mentioned of utilizing a phase separation phenomenon between the above matrix component (a raw material of an optically-transparent resin having polyene structure) and a liquid crystalline material. For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above mixed solution, some of combinations of the optically-transparent material forming the matrix, and the liquid crystal material forming minute domains do not require a dispersing agent. It will be understood that any other appropriate method may be used, but not limited, for the preparation.

An amount used of the liquid crystalline material dispersed in the matrix is not especially limited, and a liquid crystalline material is 0.01 to 100 parts by weight to an optically-transparent resin having polyene structure 100 parts by weight, and preferably it is 0.1 to 10 parts by weight.

The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the step (2) forming the mixture solution into a film, the mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying.

The step (12) is adopted to embed fibers in the above step (1), a raw material resin solution for the matrix-forming optically-transparent resin having the polyene structure may be first prepared, and the solution may be applied to birefringent fibers by any method such as coating, dipping and impregnation lamination. For example, the solution is prepared by dissolving, in an appropriate solvent, a raw material resin for the matrix-forming optically-transparent resin having the polyene structure, wherein the birefringent fiber is not soluble in the solvent. An arrangement of the fibers is coated with the solution, and the solvent is removed by drying so that a film can be formed. Another method may be used which includes coating and biding the birefringent fibers with a raw material for the optically-transparent resin and forming a film from the bound fibers with a raw material resin solution for the optically-transparent resin by such a technique as coating, dipping and impregnation lamination. A further method may also be used which includes coating and binding the birefringent fibers with a raw material for the optically-transparent resin and performing melting and press-bonding by heating, pressing and the like to form a film from the bound fibers, while degassing the resin coating part.

When the birefringent fibers are embedded using a raw material for the optically-transparent resin, in order to prevent voids, it is preferred that the viscosity of the raw material for the optically-transparent resin should be so low that air bubbles can be prevented from being entrained. If air bubbles are entrained, they can form isotropic scattering points, which are independent of polarization. Thus, the entrainment of air bubbles should preferably be prevented as much as possible. In the polarizer of the invention, voids are prevented from being formed, because if voids substantially exist, the scattering function cannot be performed. With respect to the invention, the term “without forming voids” means that voids that inhibit the scattering function are absent. Specifically, the voids refer to interstices larger than about 1/10 of the wavelength of visible light (about 50 nm).

With weft yarns, the birefringent fibers may be formed into a fabric, which may be embedded in the raw material for the optically-transparent resin to form a film. Also in this case, voids should preferably be prevented. If a fabric is formed using weft yarns, the polarizer can be produced with good workability. It should be noted, however, that since the parallelism of the birefringent fibers is slightly reduced when the fibers are woven, the polarization properties should be prevented from being degraded. While the above transparent resin may be used as a material for the weft yarns, it is preferred that its refractive index should be substantially equal to the refractive index of the polyene structure-forming optically-transparent resin. The difference between the refractive indices of the weft yarn and the polyene structure-forming optically-transparent resin is preferably at 0.02 or less, more preferably 0.01 or less, most preferably 0. In view of the reduction in polarization properties, the weft yarns are preferably as thin as possible. In view of balance with the strength of the weft yarns, the diameter of the weft yarns is preferably from about 1 to about 30 μm. While the weft yarns may have any cross-sectional shape, an elliptical cross section is preferred in view of easy production. Weaving methods that resist the reduction in the parallelism of the birefringent fibers (warp yarns) are preferably used, such as plain weaving and satin weaving. In view of polarization properties, several birefringent fibers are preferably bundled and woven as a warp yarn.

The polyene structure-forming optically-transparent resin 1 and the birefringent fibers 4 may be used in any ratio. In view of polarization performance, however, the optically-transparent resin 1 is preferably disposed in such an amount that linearly polarized light parallel to the absorption axis of the polyene structure-forming optically-transparent resin 1 can be sufficiently absorbed by the polarizer. The volume ratio of the polyene structure-forming optically-transparent resin 1 to the birefringent fibers 4 is preferably from 10:90 to 90:10, depending on the overall thickness after the embedment. If the amount of the polyene structure-forming optically-transparent resin 1 is too small, the amount of absorption of linearly polarized light parallel to the absorption axis can be insufficient so that the polarization performance can be insufficient. On the other hand, if the ratio of the polyene structure-forming optically-transparent resin 1 is too high, scattering can be insufficiently produced.

The step (3) of turning the film into a polyene may use any appropriate method depending on the raw material resin to be used. In a case where the raw material resin is polyvinyl alcohol, a dehydration reaction may be allowed to proceed so that a conjugated polyene structure can be obtained.

For example, it is generally possible to use a method that includes processing the film obtained in the step (2) in the presence of an acid catalyst and then performing a dehydration reaction by heat treatment or the like to turn the film into a polyene. Examples of the acid catalyst include, but are not limited to, inorganic acids such as hydrochloric acid and sulfuric acid and organic acids such as acetic acid, p-toluenesulfonic acid and benzoic acid. The acid catalyst may be properly used depending on the solvent to be used. For example, when water is used as the solvent, the organic acid catalyst is preferably acetic acid or p-toluenesulfonic acid. As disclosed in JP-A No. 2003-240952, halogens may be used in place of the inorganic acid. Halogens correspond to a reaction catalyst and may be removed from the film by any appropriate method after the dehydration reaction is completed or after the polarizer is produced. Halogens include fluorine, chlorine, bromine, iodine, and compounds thereof. One of these halogens may be used alone, or two or more of these halogens may be mixed and used.

The catalyst treatment is generally performed using a solution containing the catalyst. While the solvent for use in the solution may be properly selected from organic solvents and water, water is preferably used. The concentration of the catalyst in the aqueous solution is generally in the range of 0.01 to 30% by weight. The treatment with the catalyst solution may be performed by dipping the film in the catalyst solution or allowing the film to pass through the catalyst solution. The temperature of the catalyst solution is generally from about 5 to about 100° C. In general, the contact or immersion time is preferably from about 1 to about 120 minutes. Using the catalyst solution may be replaced by a method of allowing the film to pass through a catalyst-containing atmosphere.

After the treatment with the catalyst solution, the solvent deposited on the film is optionally removed by drying before heat treatment. The heat treatment is generally performed under the conditions of a heat treatment temperature of about 80 to about 200° C., preferably of 100 to 180° C., and a heat treatment time of about 1 to about 120 minutes. The heat treatment may be any of batch treatment and continuous treatment.

The step (3) orienting the above film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives. A stretching ratio is not especially limited, and in usual a ratio of about 2 to about 10 times is preferably adopted.

This stretching may orient the optically-transparent resin 1 having polyene structure in a direction of stretching axis. Moreover, the liquid crystalline material forming the minute domains 2 is oriented in the stretching direction in the minute domains by the above stretching, and as a result birefringence is demonstrated. Concerning the birefringent material that forms the fibers 4, birefringence and orientation in the stretching direction can be produced and/or improved in the fibers by the stretching.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above stretching, function of external fields, such as electric field and magnetic field, may be used for orientation of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be oriented by orientation processing with light irradiation etc. Furthermore, a stretching processing and the above orientation processing may also be used in combination. When the liquid crystalline material is of liquid crystalline thermoplastic resins, it is oriented at the time of stretching, cooled at room temperatures, and thereby orientation is fixed and stabilized. In curing of a liquid crystalline monomer, for example, after the liquid crystalline monomer is mixed with photopolymerization initiators, dispersed in a solution of a matrix component and oriented, in either of timing, the liquid crystalline monomer is cured by exposure with ultraviolet radiation etc. to stabilize orientation.

Besides the steps (1) to (4), the process of manufacturing the polarizer may further include the step (5) of optionally adding the dichroic light-absorbing material 3 or any other resin component containing the dichroic light-absorbing material 3 to the optically-transparent resin 1 having the polyene structure. For example, the step (5) of dispersing (adding) the dichroic light-absorbing material 3 may be performed as needed after the film is formed in the step (2). Examples of the step include a method of immersing the film in a bath of a solution of the dichroic light-absorbing material in a solvent and a method of coating the film with a solution containing the dichroic light-absorbing material. The timing of the immersion may be before or after the stretching step (4). The concentration of the dichroic dye solution used in this step and the use of an auxiliary agent or the like may be arbitrary. By the stretching step (4), the dichroic light-absorbing material 3 can be oriented in the stretching axis direction.

A percentage of the dichroic light-absorbing material in the polarizer obtained is not especially limited, but a percentage of the optically-transparent resin having polyene structure and the dichroic light-absorbing material are preferably controlled so that the dichroic light-absorbing material is 0.05 to 50 parts by weight grade to the optically-transparent resin having polyene structure 100 parts by weight, and more preferably 0.1 to 10 parts by weight.

Besides the steps (1) to (4) and optionally the step (5), the process of manufacturing the polarizer may further include the step (6) for various purposes. Examples of the step (6) include the step of allowing the film to swell by immersing it in an appropriate solvent for the main purpose of improving the efficiency of dyeing the film and the step of adding an additive to the film or immersing the film in an additive-containing solution for the purpose of adjusting the balance of the amount of the dichroic light-absorbing material and adjusting the hue.

The step (4) of orienting (stretching) the film, the step (5) of dispersing the dichroic light-absorbing material for dyeing and the step (6) may be performed any selected number of times, in any selected order, and under any selected conditions (such as bath temperature and immersion time). These steps may be each independently performed, or two or more of these steps may be performed at the same time. For example, the step (3) of turning into the polyene and the orienting (stretching) step (4) may be performed at the same time. The step (5) of preliminarily dispersing the dichroic light-absorbing material may be simultaneously performed in the step (1) and/or the step (4). If the step (5) is performed plural times, the respective steps may use the same or different dichroic light-absorbing materials.

A film performed the above treatments is desirably dried using suitable conditions. Drying is performed according to conventional methods.

A thickness of the obtained polarizer (film) is not especially limited, in general, but it is 1 μm to 5 mm, preferably 5 μm to 3 mm, and more preferably 10 μm to 1 mm.

A polarizer obtained in this way does not especially have a relationship in size between a refractive index of the liquid crystalline material forming minute domains and/or the birefringent fibers and a refractive index of the matrix resin in a stretching direction, whose stretching direction is in a Δn¹ direction and two directions perpendicular to a stretching axis are Δn² directions. Moreover, the stretching direction of a dichroic light-absorbing material is in a direction demonstrating maximal absorption, and thus a polarizer having a maximally demonstrated effect of absorption and scattering may be realized.

Since a polarizer obtained by this invention has equivalent functions as in existing absorbed type polarizing plates, it may be used in various applicable fields where absorbed type polarizing plates are used without any change.

The above-described polarizer may be used as a polarizing plate with a transparent protective layer prepared at least on one side thereof using a usual method. The transparent protective layer may be prepared as an application layer by polymers, or a laminated layer of films. Proper transparent materials may be used as a transparent polymer or a film material that forms the transparent protective layer, and the material having outstanding transparency, mechanical strength, heat stability and outstanding moisture interception property, etc. may be preferably used. As materials of the above protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above polymers may be mentioned. Films made of heat curing type or ultraviolet ray curing type resins, such as acryl based, urethane based, acryl urethane based, epoxy based, and silicone based, etc. may be mentioned.

Moreover, as is described in JP-A No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

As a transparent protection layer if polarization property and durability are taken into consideration, cellulose based polymer, such as triacetyl cellulose, is preferable, and especially triacetyl cellulose film is suitable. In general, a thickness of a transparent protection layer is 500 μm or less, preferably 1 to 300 μm, and especially preferably 5 to 300 μm. In addition, when transparent protection layers are provided on both sides of the polarizer, transparent protection films comprising same polymer material may be used on both of a front side and a back side, and transparent protection layers comprising different polymer materials etc. may be used.

Moreover, it is preferable that the transparent protection film may have as little coloring as possible. Accordingly, a protection film having a retardation value in a film thickness direction represented by Rth=(nx−nz)×d of −90 nm to +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protection film may mostly be cancelled using a protection film having a retardation value (Rth) of −90 nm to +75 nm in a thickness direction. The retardation value (Rth) in a thickness direction is preferably −80 nm to +60 nm, and especially preferably −70 nm to +45 nm.

If the optically-transparent resin having the polyene structure that forms the matrix of the polarizer obtained according to the invention, the minute domain-forming material, the fiber-forming material, and the dichroic light-absorbing material are each sufficient in heat resistance, mechanical properties such as dimensional stability and reliability, the polarizer itself may be used as a polarizing plate with no transparent protective layer formed thereon.

A hard coat layer may be prepared, or antireflection processing, processing aiming at sticking prevention, diffusion or anti glare may be performed onto the face on which the polarizer of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above antireflection layer, sticking prevention layer, diffusion layer, anti glare layer, etc. may be built in the protective film itself, and also they may be prepared as an optical layer different from the protective layer.

Adhesives are used for adhesion processing of the above described polarizer and the transparent protective film. As adhesives, isocyanate derived adhesives, polyvinyl alcohol derived adhesives, gelatin derived adhesives, vinyl polymers derived latex type, aqueous polyesters derived adhesives, etc. may be mentioned. The above-described adhesives are usually used as adhesives comprising aqueous solution, and usually contain solid of 0.5 to 60% by weight.

A polarizing plate of the present invention is manufactured by adhering the above described transparent protective film and the polarizer using the above described adhesives. The application of adhesives may be performed to any of the transparent protective film or the polarizer, and may be performed to both of them. After adhered, drying process is given and the adhesion layer comprising applied dry layer is formed. Adhering process of the polarizer and the transparent protective film may be performed using a roll laminator etc. Although a thickness of the adhesion layer is not especially limited, it is usually approximately 0.1 to 5 μm.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above protective film, on which a reflective layer of concavo-convex structure is prepared, may be mentioned. The reflective layer that has the above fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transfilective type polarizing plate may be obtained by preparing the above reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transfilective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above polarizing plate may be used as elliptically polarizing plate or circularly polarizing plate on which the retardation plate is laminated. A description of the above elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyallylates and polyamides; oriented films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above elliptically polarizing plate and an above reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction, to a screen. As such a viewing angle compensation retardation plate, in addition, a film having birefringence property that is processed by uniaxial stretching or orthogonal bidirectional stretching and a bidriectionally stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above separated type polarizing plate. Therefore, a polarizing plate may be a reflection type elliptically polarizing plate or a semi-transmission type elliptically polarizing plate, etc. in which the above reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

An optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that an optical film by the present invention is used, there is especially no limitation to use any conventional methods. Also any liquid crystal cell of arbitrary type, such as TN type, and STN type, π type may be used.

Suitable liquid crystal displays, such as liquid crystal display with which the above optical film has been located at one side or both sides of the liquid crystal cell, and with which a backlight or a reflector is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Examples of this invention will, hereinafter, be shown, and specific descriptions will be provided. In addition, “parts” in following sections represents parts by weight.

### Example 1

A polyvinyl alcohol aqueous solution of 13% by weight of solid content in which a polyvinyl alcohol resin having a degree of polymerization of 2400 and a 98.5% of a degrees of saponification were dissolved; a liquid crystalline monomer (nematic liquid crystal temperature range is 40 to 70° C.) having acryloyl groups at each terminal of both of a mesogen group; and glycerin were mixed so as to be polyvinyl alcohol: liquid crystalline monomer: glycerin=100:15 (weight ratio), and the mixture was heated more than a liquid crystal temperature range, and was agitated with a homogeneous mixer to obtain a mixed solution. After degassing of bubbles existing in the mixed solution concerned by left to stand at room temperature (23° C.), the mixed solution was coated by a casting method, and a cloudy film having a thickness of 70 μm was obtained after drying.

The film was stretched about 3 times in a bath composed of an aqueous 0.5% by weight hydrochloric acid solution at 10° C., dried in a drier at 65° C. for 15 minutes, then stretched in a drier at 130° C. such that the total stretch ratio reached 6, and heat-treated in a drier at 130° C. for 30 minutes so that a polarizer according to the invention was obtained.

(Confirmation of Generation of Anisotropic Scattering and Measurement of Refractive Index)

The obtained polarizer was observed under a polarization microscope and it was able to be confirmed that numberless dispersed minute domains of a liquid crystalline monomer were formed in a resin having polyene structure. The liquid crystalline monomer is oriented in a stretching direction and an average size of minute domains in the stretching direction (Δn² direction) was in the range of from 5 to 10 μm. It is confirmed that a matrix of the obtained polarizer is a resin having polyene structure with observing a spectrum of absorbance and a polarization separated function.

Refractive indices of the matrix and the liquid crystalline (minute domains) were separately measured. Measurement was conducted at 20° C. A refractive index of a stretched film constituted only of a resin film having polyene structure stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (nₑ: an extraordinary light refractive index and no: an ordinary light refractive index) of the liquid crystalline monomer were measured. An ordinary light refractive index no was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K.K.) and a cell gap (d) was measured separately with an optical interference method to calculate Δn from retardation/cell gap and to obtain the sum of Δn and no as nₑ. An extraordinary light refractive index nₒ (corresponding to a refractive index in the Δn¹ direction)=1.64 and no (corresponding to a refractive index of Δn² direction)=1.52. Therefore, calculation was resulted in Δn¹=1.64−1.52=0.10 and Δn²=1.52−1.52=0.00. It was confirmed from the measurement described above that a desired anisotropic scattering was able to occur.

### Example 2

A polarizer according to the invention was obtained using the process of Example 1, except that the time of the heat treatment at 130° C. after the stretching was changed to 15 minutes.

### Example 3

A polarizer according to the invention was obtained using the process of Example 1, except that when the mixture solution for use in manufacturing the polarizer was prepared, a hydrophilic dichroic dye (INK GREY B manufactured by Clariant (Japan) K.K. was mixed such that the weight ratio of the polyvinyl alcohol/the liquid-crystalline monomer/the dichroic dye/glycerin was 100/5/0.5/15.

### Example 4

Resin pellets of an ethylene-vinyl alcohol copolymer (EVOH manufactured by Kuraray Co., Ltd. with an ethylene content of 27%) were dried under vacuum at 105° C. and then fed to a uniaxial extruder equipped with a monofilament die (cylinder temperature: 180° C., 220° C.; die temperature: 220° C.) to give fibers with a diameter of 37 μm.

A solution was prepared by mixing glycerin and an aqueous polyvinyl alcohol solution with a solids content of 13% by weight, in which a polyvinyl alcohol resin with a degree of polymerization of 2400 and a saponification degree of 98.5% was dissolved, in such a manner that in terms of solid content, 100 parts by weight of the polyvinyl alcohol was mixed with 15 parts by weight of glycerin. The fibers obtained as described above were arranged in parallel on a steel plate (SUS304) and coated with the solution so as to be embedded and then dried at 120° C. for 30 minutes to form a 70 μm-thick film. The weight ratio of the matrix-forming polyvinyl alcohol resin to the fibers was 100:100 (parts by weight).

The resulting film was stretched in the same manner as in Example 1 to give a polarizer according to the invention. On the other hand, the resulting fibers were stretched 6 times at 130° C. The stretched fibers had a diameter of 15 μm, a refractive index nₒ1 of 1.52 in the cross-sectional direction and a birefringence Δn of 1.55. The refractive index is a value measured at room temperature (20° C.) with respect to a wavelength of 545 nm. The refractive index was measured with a refractive index-adjusting solution by Becke line method. The birefringence was measured using a Berek compensator.

### Comparative Example 1

A polarizer according to the invention was obtained using the process of Example 1, except that the liquid-crystalline monomer was not added when the mixture solution for use in manufacturing the polarizer was prepared.

### Comparative Example 2

A polarizer according to the invention was obtained using the process of Example 2, except that the liquid-crystalline monomer was not added when the mixture solution for use in manufacturing the polarizer was prepared.

### Comparative Example 3

A polarizer according to the invention was obtained using the process of Example 3, except that the liquid-crystalline monomer was not added when the mixture solution for use in manufacturing the polarizer was prepared.

### Comparative Example 4

An aqueous polyvinyl alcohol solution with a solids content of 13% by weight, in which a polyvinyl alcohol resin with a degree of polymerization of 2400 and a saponification degree of 98.5% was dissolved, was applied by casting method and subsequently dried to form a 70 μm-thick film. The film was wet-stretched by subjecting it to the steps of: (A) immersing it in a water bath at 30° C. to allow it to swell and stretching it 3 times; (B) immersing it in an aqueous solution of iodine and potassium iodide (1:7 in weight ratio) (with a concentration of 0.32% by weight) at 30° C. to dye it; (C) immersing it in an aqueous solution of 3% by weight boric acid at 30° C. to crosslink it; (D) further immersing it in an aqueous solution of 4% by weight boric acid at 60° C. and stretching it 2 times (6 times in total); and (E) immersing it in a bath of an aqueous solution of 5% by weight potassium iodide at 30° C. to adjust the hue. The film was subsequently dried at 50° C. for 4 minutes to give a polarizer.

(Evaluation)

Polarizers (sample) obtained in Examples and Comparative examples were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard calorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction. The results are shown in Table 1.

A polarization degree P was calculated with an equation P={(k₁−k₂)/(k₁+k₂)}×100. A transmittance T of a simple substance was calculated with an equation T=(k₁+k₂)/2.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated.

In evaluation of unevenness, in a dark room, a sample (polarizer) was arranged on an upper surface of a backlight used for a liquid crystal display, furthermore, a commercially available polarizing plate (NPF-SEG1224DU by NITTO DENKO CORP.) was laminated as an analyzer so that a polarized light axis may intersect perpendicularly. And a level of the unevenness was visually observed on following criterion using the arrangement. The results are shown in Table 1.

x: a level in which unevenness may visually be recognized

◯: a level in which unevenness may not visually be recognized.

TABLE 1

| | Transmittance of linearly | | | | | | |
|---|---|---|---|---|---|---|---|
| | polarized light (%) | | Single | | haze value (%) | | |
| | Maximum | Perpendicular | substance | | Maximum | | |
| | transmission | direction | transmittance | Polarization | transmission | Perpendicular | |
| | direction (k₁) | (k₂) | (%) | degree (%) | direction | direction | Unevenness |
| Example 1 | 65.4 | 0.0131 | 32.7 | 99.96 | 1.5 | 82.0 | ∘ |
| Example 2 | 64.0 | 0.0064 | 32.0 | 99.98 | 1.6 | 81.5 | ∘ |
| Example 3 | 85.5 | 0.0427 | 42.8 | 99.90 | 1.5 | 82.0 | ∘ |
| Example 4 | 65.5 | 0.0083 | 32.8 | 99.97 | 1.4 | 82.5 | ∘ |
| Comparative | 63.5 | 15.628 | 39.6 | 60.50 | 0.1 | 0.2 | x |
| Example 1 | | | | | | | |
| Comparative | 63.8 | 9.3651 | 36.6 | 74.40 | 0.2 | 0.2 | x |
| Example 2 | | | | | | | |
| Comparative | 85.0 | 8.9746 | 47.0 | 80.90 | 0.2 | 0.1 | x |
| Example 3 | | | | | | | |
| Comparative | 87.0 | 0.0430 | 43.5 | 99.90 | 0.2 | 0.2 | x |
| Example 4 | | | | | | | |

Table 1 above indicates that the transmittance and the degree of polarization are both good in each of Examples. It is apparent that the polarizer has a higher haze value in each of Examples than in each of Comparative Examples with respect to the perpendicular transmittance so that unevenness due to variations is masked by scattering and is not detectable in each of Examples.

(Evaluation of Resistance to Heat and Humidity)

To both sides of the polarizer obtained in each of Examples and Comparative Examples, 80 μm-thick saponified triacetylcellulose films serving as protective films were bonded using an adhesive prepared by adding glyoxal to polyvinyl alcohol, and dried at 60° C. for 5 minutes so that a polarizing plate was obtained. The resulting polarizing plate was evaluated as described below. The results are shown in Table 2.

<Immersion Test in Hot Water>

The polarizing plate was cut into a size of 50 mm×50 mm. The cut piece was immersed in hot water at 70° C., while the time until any one of the sides was completely peeled off was determined.

<Heat and Humidity Resistance of Polarizing Plate>

The polarizing plate was heated under the hot and humid conditions of 60° C. and 95% RH for 1000 hours. The transmittance and degree of polarization of the polarizing plate were measured by the same method as described above before and after the heating, and a change in the state (before heating-after heating) was determined.

TABLE 2

| | | Resistance to Heat and | |
|---|---|---|---|
| | Immersion Test in | Humidity: Amount of Change | |
| | Hot Water: Time | Single-Substance | Degree of |
| | Until Peeling of | Transmittance | Polarization |
| Polarizing Plate | Protective Film | [%] | [%] |
| Example 1 | at least 120 | 1.2 | −0.3 |
| | minutes | | |
| Example 2 | at least 120 | 1.1 | −0.3 |
| | minutes | | |
| Example 3 | at least 120 | 1.2 | −0.4 |
| | minutes | | |
| Example 4 | at least 120 | 1.1 | −0.3 |
| | minutes | | |
| Comparative | at least 120 | 1.3 | −0.5 |
| Example 1 | minutes | | |
| Comparative | at least 120 | 1.4 | −0.5 |
| Example 2 | minutes | | |
| Comparative | at least 120 | 1.4 | −0.5 |
| Example 3 | minutes | | |
| Comparative | 30 minutes | 3.0 | −2.9 |
| Example 4 | | | |

Table 2 above indicates that the resistance to heat and humidity is good in each of Examples.

### INDUSTRIAL APPLICABILITY

The polarizer of the invention can be used for polarizing plates and optical films, which are suitable for use in image displays such as liquid crystal displays, organic electroluminescent displays, cathode ray tubes (CRTs), and plasma display panels (PDPs).

1-18. (canceled)

19. A polarizing plate comprising: a polarizer and a protective film laminated on one or both sides of the polarizer with an adhesive layer, wherein
the polarizer comprises a monolayer film having a structure having a minute domain dispersed in a matrix formed of an optically-transparent water-soluble resin including an iodine based light absorbing material, and
the adhesive layer is made of an adhesive that contains a resin curable with an active energy beam or an active material.

20. The polarizing plate according to claim 19, wherein the minute domain of the polarizer is formed of an oriented birefringent material.

21. The polarizing plate according to claim 20, wherein the birefringent material shows liquid crystalline.

22. The polarizing plate according to claim 20, wherein the minute domain of the polarizer has 0.02 or more of birefringence.

23. The polarizing plate according to claim 20, wherein in a refractive index difference between the birefringent material forming the minute domain and the optically-transparent water-soluble resin of the polarizer in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

24. The polarizing plate according to claim 23, wherein an absorption axis of the iodine based light absorbing material of the polarizer is oriented in the Δn¹ direction.

25. The polarizing plate according to claim 19, wherein the film used as the polarizer is manufactured by stretching.

26. The polarizing plate according to claim 23, wherein the minute domain of the polarizer has a length of 0.05 to 500 μm in the Δn² direction.

27. The polarizing plate according to claim 19, wherein an iodine based light absorbing material of the polarizer has an absorbing band at least in a band of 400 to 700 nm wavelength range.

28. The polarizing plate according to claim 19, wherein the adhesive is an active energy beam-curable solventless adhesive or a moisture-curable one-component adhesive.

29. The polarizing plate according to claim 19, wherein the protective film has a bonded surface that has been subjected to at least one treatment selected from corona treatment, plasma treatment, flame treatment, primer coating treatment, and saponification treatment.

30. The polarizing plate according to claim 19, wherein the protective film has an in-plane retardation Re=(nx−ny)×d is 20 nm or less and a thickness direction retardation Rth={(nx+ny)/2−nz}×d is 30 nm or less,
where a direction of a transparent protective film in which an in-plane refractive index within the film surface concerned gives a maximum is defined as X-axis, a direction perpendicular to X-axis is defined as Y-axis, a thickness direction of the film is defined as Z-axis, refractive indices in axial direction are defined as nx, ny, and nz, respectively, and a thickness of the film is defined as d (nm).

31. The polarizing plate according to claim 30, wherein the protective film comprises at least one selected from a resin composition containing a thermoplastic resin (A) having a substituted and/or non-substituted imide group in a side chain and a thermoplastic resin (B) having substituted and/or non-substituted phenyl group and nitrile group in a side chain, and the norbornene resin.

32. The polarizing plate according to claim 19, wherein a transmittance to a linearly polarized light in a transmission direction is 80% or more, a haze value is 5% or less, and
a haze value to a linearly polarized light in an absorption direction is 30% or more.

33. An optical film comprising at least one of the polarizing plate according to claim 19.

34. An image display comprising at least one polarizing plate according to claim 19.

35. An image display comprising at least one optical film according to claim 33.
